(19) United States
(12) Patent Application Publication
(10) Pub. No.: US 2016/0314678 A1
(43) Pub. Date: Oct. 27, 2016

(54) WHISTLE CAPABLE OF DETECTING AIR PRESSURE

(71) Applicant: Chia-Hung HSIEH, Taipei City (TW)

(72) Inventor: Chia-Hung HSIEH, Taipei City (TW)

(21) Appl. No.: 15/134,113

(22) Filed: Apr. 20, 2016

(30) Foreign Application Priority Data
Apr. 21, 2015 (TW) 104206044

(51) Int. Cl. G08B 21/18; G01F 1/66; G10K 5/00

(52) U.S. Cl. CPC G08B 21/182; G10K 5/00; G01F 1/666

(57) ABSTRACT

A whistle capable of detecting an air pressure includes a housing and a circuit board module. The housing further includes a shell body and a division assembly. The shell body has an interior space. The division assembly dividing the interior space into an air chamber and an accommodation chamber further has a detection opening communicative in space with the air chamber. The air chamber has a blow hole for a user to blow an air into the air chamber. The circuit board module located in the shell body includes a main board and an air-pressure sensor. The main board partly at least located in the accommodation chamber has an air-detecting region respective to the detection opening The air-pressure sensor mounted in the air-detecting region is to detect the air and to transmit a corresponding detection signal upon detecting the air.

### BACKGROUND OF INVENTION

1. Field of the Invention

The invention relates to a whistle capable of detecting an air pressure, and more particularly to the whistle having an air-pressure detector to detect the air and to further transmit the air-pressure detection signal out of the whistle.

2. Description of the Prior Art

The whistle makes sound easily that it is widely used as a noise-making means for any alert purpose at various applications. Nowadays, with the rising crimes and natural disasters, its advantages of being portable, simple, and low-cost have made the whistle as one of popular gadgets for emergency alert. However, in a noisy environment, various sounds from different places might distract the attention gathered by this noise-making purpose, unfortunately it is usually the case that an accident or emergent scene is always crowded with people and thus filled with unexpected sounds. Thus, a sound from a whistle purposely to alerting specific people might be easily ignored, or the sound from the whistle might not be quickly located. As a result of the above, the current whistle does need further improvement to cope with the aforesaid disadvantages.

Though the high-pitched tone generated by the whistle is helpful for people to quickly position the whistle blower, yet an inevitable problem therefrom is its short propagation range. The low-pitched tone, on the other hand, may have long-distance transmission but hard to be discovered. In reality, the SOS signals made by the conventional whistle can't efficiently help rescue team to locate the accident place if where the accident is not in a reachable range of the high-pitched sound. Further, in considering the composition of the rescue team, the favorite tones for different people may vary from age to age. For example, to elder persons, the lower tone is a favor, and the high tone might be neglected. Therefore, it is obvious that an improved whistle capable to make both high-pitched and low-pitched sound can contribute to rescue efficiency.

### SUMMARY OF THE INVENTION

As described above, since the whistling of a conventional whistle can't help much for the rescue team to locate a precise position of the user, so an improved whistle structure is necessary and worthy to the art.

Accordingly, it is the primary object of the present invention to provide a whistle capable of detecting an air pressure, which detects an air blown by a user and generates a corresponding detection signal for outward transmission.

In the present invention, the whistle capable of detecting an air pressure includes a housing and a circuit board module. The housing further includes a shell body and a division assembly. The shell body has an interior space. The division assembly dividing the interior space into an air chamber and an accommodation chamber further has a detection opening communicative in space with the air chamber. The air chamber has a blow hole for a user to blow an air into the air chamber. The circuit board module located in the shell body includes a main board and an air-pressure sensor. The main board partly at least located in the accommodation chamber has an air-detecting region respective to the detection opening. The air-pressure sensor mounted in the air-detecting region is to detect the air and to transmit a corresponding detection signal upon detecting the air.

In one embodiment of the present invention, the air-pressure sensor is inserted in the detection opening, and the circuit board module includes a transmission module electrically coupled with the air-pressure sensor for connecting communicatively an electronic mobile device, in which the transmission module transmits the first detection signal to the electronic mobile device after receiving the first detection signal. Further, the housing further includes a depression member, and the circuit board module further includes a pressure-detecting member mounted on the main board with respect to the depression member and electrically coupled with the transmission module, in which the pressure-detecting member transmits a second detection signal to the electronic mobile device through the transmission module upon the depression member being depressed. In addition, the circuit board module further includes a light-emitting module mounted on the main board and electrically coupled with the air-pressure sensor and the pressure-detecting member, the light-emitting module being to light on upon receiving at least one of the first detection signal and the second detection signal.

In one embodiment of the present invention, circuit board module include a power supply module, the circuit board module further includes a power supply module mounted on the main board and electrically coupled with the light-emitting module, in which the power supply module is to energize the light-emitting module. The power supply module can be one of a lithium battery, an alkaline battery, a chargeable battery and an aluminum battery. Further, the air chamber further has a first acoustic window and a second acoustic window isolated from the first acoustic window, and the shell body further includes an upper housing and a lower housing. The upper housing has a first acoustic outlet and a second acoustic outlet separated from the first acoustic outlet by at least one separation plate. The first acoustic outlet is communicative in space with the first acoustic window, and the second acoustic outlet is communicative in space with the second acoustic window. The upper housing and the lower housing are connected structurally by the division assembly. In addition, the division assembly further includes a first division plate and a second division plate, in which the first division plate and the second division plate are connected to the upper housing and the lower housing, respectively. The second division plate further includes a first planar portion, a vertical portion and a second planar portion, in which the first planar portion has the detection opening The vertical portion connects the first planar portion and the second planar portion at both ends thereof so as integrally to form an L-shaped structure.

Hence, by providing the whistle capable of detecting an air pressure in accordance with the present invention, since the air-pressure sensor is introduced to detect the air of user's whistling, and since the detection signal is transmitted to distant foreign electronic mobile devices, so messages of user's urgent need can be clearly understood through the transmission of the internet.

In addition, since the air chamber is divided into two voice channels for making simultaneously the lower tone and the high tone respectively, the rescue team rushing to help can easily locate the user, even at a circumstance of invisible night or dense fog, such that the rescue efficiency can be substantially enhanced.

All these objects are achieved by the whistle capable of detecting an air pressure described below.

### BRIEF DESCRIPTION OF THE DRAWINGS

The present invention will now be specified with reference to its preferred embodiment illustrated in the drawings, in which:

FIG. 1 is a schematic perspective view of the preferred whistle capable of detecting an air pressure in accordance with the present invention;

FIG. 2 is a cross sectional view of FIG. 1 along line A-A;

FIG. 3 is a cross sectional view of FIG. 1 along line B-B;

FIG. 4 is an explode view of FIG. 1;

FIG. 5 is another exploded view of FIG. 1; and

FIG. 6 shows an application of the preferred whistle capable of detecting an air pressure in accordance with the present invention, in which the whistle is communicative with an electronic mobile device.

### DESCRIPTION OF THE PREFERRED EMBODIMENT

The invention disclosed herein is directed to a whistle capable of detecting an air pressure. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

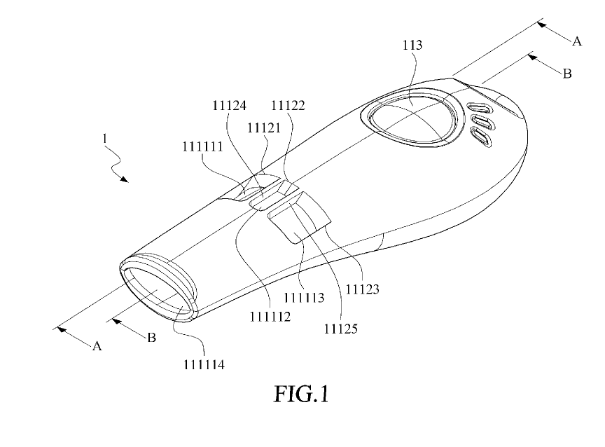

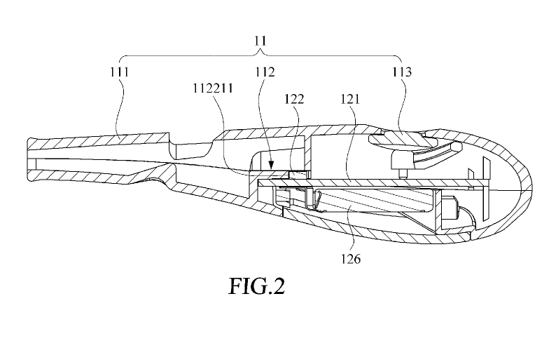

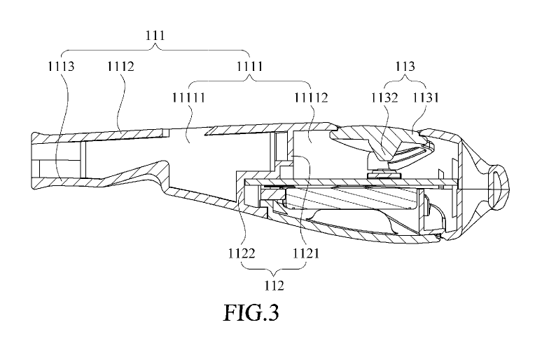

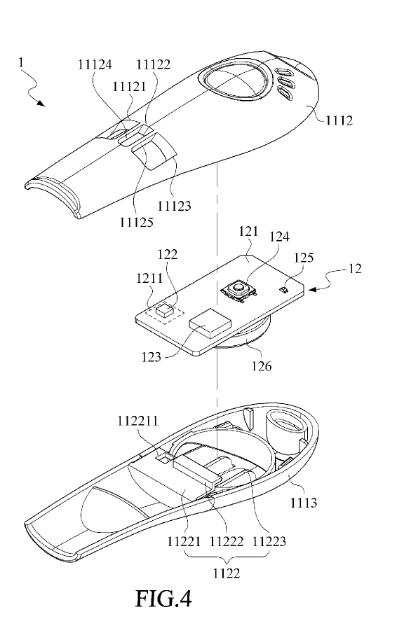

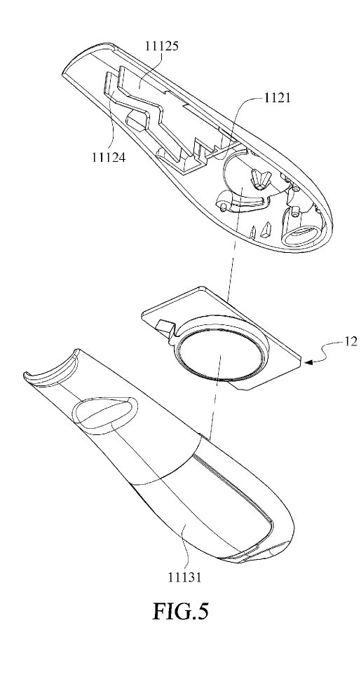

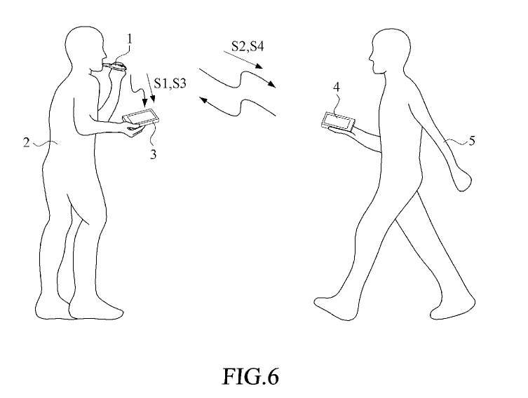

Refer now to FIG. 1 through FIG. 6, in which FIG. 1 is a schematic perspective view of the preferred whistle capable of detecting an air pressure in accordance with the present invention, FIG. 2 is a cross sectional view of FIG. 1 along line A-A, FIG. 3 is a cross sectional view of FIG. 1 along line B-B, FIG. 4 is an explode view of FIG. 1, FIG. 5 is another exploded view of FIG. 1, and FIG. 6 shows an application of the preferred whistle capable of detecting an air pressure in accordance with the present invention, in which the whistle is communicative with an electronic mobile device.

As shown, the preferred whistle capable of detecting an air pressure 1 includes a housing 11 and a circuit board module 12. The housing 11 further includes a shell body 111, a division assembly 112 and a depression member 113. The shell body 111 has an interior space 1111, and includes an upper housing 1112 and a lower housing 1113, in which the interior space 1111 is divided to have an air chamber 11111 and an accommodation chamber 11112. The air chamber 11111 further has a first acoustic window 111111, a second acoustic window 111112 and a third acoustic window 111113, in which the first acoustic window 111111, the second acoustic window 111112 and the third acoustic window 111113 are all structurally isolated from each other. In addition, the air chamber 11111 further has a blow hole 111114 for a user 2 to blow an air into the air chamber 11111 so as to allow the air to flow around the first acoustic window 111111, the second acoustic window 111112 and the third acoustic window 111113.

The upper housing 1112 further has a first acoustic outlet 11121, a second acoustic outlet 11122 and a third acoustic outlet 11123, and also has at least one separation plate 11124, 11125 (two shown in the figures). The first acoustic outlet 11121 is communicative in space with the first acoustic window 111111, the second acoustic outlet 11122 is communicative in space with the second acoustic window 111112, and the third acoustic outlet 11123 is communicative in space with the third acoustic window 111113. As shown, the separation plate 11124 is to separate the first acoustic window 111111 from the second acoustic window 111112, and the separation plate 11125 is to separate the second acoustic window 111112 from the third acoustic window 111113. Further, in the preferred embodiment, the area of cross section of the first acoustic outlet 11121 is larger than that of the second acoustic outlet 11122, but is smaller than that of the third acoustic outlet 11123. Upon such an arrangement in varying the sizes of the acoustic windows, various voice channels with different frequency combinations can thus be formed, so that the air blown into the air chamber 11111 can thus induce various tones of the sound.

The division assembly 112 connecting structurally the upper housing 1112 and the lower housing 1113 is to divide the interior space 1111 into the air chamber 11111 and the accommodation chamber 11112. The division assembly 112 further has a detection opening 112211 to communicate in space with the air chamber 11111. In details, the division assembly 112 is consisted of a first division plate 1121 and a second division plate 1122, in which the first division plate 1121 is connected with the upper housing 1112 and the second division plate 1122 is connected with the lower housing 1113. In addition, the second division plate 1122 further includes integrally a first planar portion 11221, a vertical portion 11222 and a second planar portion 11223, in which the first planar portion 11221 has the detection opening 112211, and the vertical portion 11222 is to connect the first planar portion 11221 and the second planar portion 11223 so as to form an L shape structure as shown in FIG. 4. It shall be noted in this preferred embodiment that the vertical portion 11222 is erected from a portion of the first planar portion 11221 and is located at the same lateral side of the first planar portion 11221 with the detection opening 112211. In addition, the detection opening 112211 is formed as, but not limited to, a square hole.

The depression member 113 mounted at the upper housing 1112 is a conventional push button structure or any the like in the art. As shown in this embodiment, the depression member 113 has a depression portion 1131 and a protrusion portion 1132 connected with the depression portion 1131, integrally as a unique piece or by any relevant kind of connection.

The circuit board module 12, typically a printed circuit board (PCB) assembly, is located inside the shell body 111, and further includes a main board 121, an air-pressure sensor 122, a transmission module 123, a pressure-detecting member 124, a light-emitting module 125 and a power supply module 126. The main board 121 has a portion thereof, at least, to be located inside the accommodation chamber 11112. As shown in the preferred embodiment, the main board 121 is completely located inside the accommodation chamber 11112, and has an air-detecting region 1211 respectively in position to the detection opening 112211. In the present invention, the main board 121 can be a PCB.

In this preferred embodiment, the air-pressure sensor 122 is mounted in the air-detecting region 1211 and inserted into the detection opening 112211. However, in some other embodiments, the air-pressure sensor 122 can be protrusive out of the air chamber 11111, namely partly out of the air-detecting region 1211 and partly inside the detection opening 112211. In the present invention, the air-pressure sensor 122 can be an air-pressure detector.

The transmission module 123 is electrically coupled with the air-pressure sensor 122 through the main board 121, and is to connect in communication with an electronic mobile device 3. The transmission module 123 can be one of, but not limited to, a Bluetooth transmission interface, a WIMAX transmission interface, a WIFI transmission interface and an LTE transmission interface. The pressure-detecting member 124 is mounted on the main board 121 at a place corresponding to the depression member 113, and is electrically coupled with the transmission module 123 through the main board 121. In practice, the pressure-detecting member 124 on the main board 121 is disposed at a position in correspondence with the depression member 113 on the upper housing 1112, particularly by having the protrusion portion 1132 of the depression member 113 to be respective to the pressure-detecting member 124. In the present invention, the pressure-detecting member 124 can be a pressure sensor.

The light-emitting module 125 mounted on the main board 121 is electrically coupled with the air-pressure sensor 122 and the pressure-detecting member 124 through the main board 121. In this embodiment, the light-emitting module 125 is consisted of a plurality of LEDs. In some other embodiments of the present invention, the light-emitting module 125 can be consisted of OLEDs, AMOLEDs, and the light-emitting components the like. The power supply module 126 mounted on the main board 121 is electrically coupled with the light-emitting module 125 through the main board 121. In the present invention, the power supply module 126 can be one of a lithium battery, an alkaline battery, a chargeable battery and an aluminum battery. It is worthy to note that, in this preferred embodiment, the air-pressure sensor 122, the transmission module 123, the pressure-detecting member 124 and the light-emitting module 125 are all mounted on the same side of the main board 121, but the power supply module 126 is mounted to the opposite side of the main board 121.

In applications of the whistle capable of detecting an air pressure 1 according to the present invention as shown in FIG. 6, the air-pressure sensor 122 is to detect the air. While the air-pressure sensor 122 detects a situation that the user 2 blows an air into the air chamber 11111, the air-pressure sensor 122 would generate and transmit a first detection signal S1. After the transmission module 123 receives the first detection signal S1, the first detection signal S1 would be further forwarded to the electronic mobile device 3. Then, the electronic mobile device 3 would broadcast or transmit a first informing signal S2 to the electronic mobile device 4 through an internet, such that the user 5 holding the electronic mobile device 4 or the whistle 1 with the air-pressure sensor can be informed. In the present invention, the electronic mobile device 4 and the whistle 1 can be integrally by Bluetooth communication, and the electronic mobile device 4 loaded with the executable application programs can receive the first detection signal S1 anytime if and only if the program is performed. In the present invention, the aforesaid electronic mobile device 3 or 4 can be a smart phone, a smart watch, a tablet computer or any wearable device. In addition, the pressure-detecting member 124 is to transmit a second detection signal S3 to the electronic mobile device 3 through the transmission module 123, if a situation that the depression portion 1131 of the depression member 113 is depressed by the user 2 to drive the protrusion portion 1132 to contact the pressure-detecting member 124 is detected. Then, the electronic mobile device 3 would forward a second informing signal S4 to the electronic mobile device 4 through the internet, such that any user 5 who holds the electronic mobile device 4 can be informed.

Further, it shall be noted that FIG. 6 is only schematically drawn and shall not be read as the user 5 is close to the user 2. In some other embodiments, after the transmission module 123 receives the first detection signal S1, the first detection signal S1 can be directly forwarded to the electronic mobile device 4. In the transmission module 123, a memory or the like storage device can be installed, particularly in which the storage device may store a content of address book. The transmission module 123 can adopt an LTE transmission interface. Upon such an arrangement, the transmission module 123 can directly communicate with the electronic mobile device 4 of the user 5.

When the light-emitting module 125 receives at least one of the first detection signal S1 and the second detection signal S3, the light-emitting module 125 would be triggered to light on by a trigger circuit built in the main board 121 or in the light-emitting module 125 itself The power supply module 126 is to energize the light-emitting module 125, the main board 121, the air-pressure sensor 122, the transmission module 123 and the pressure-detecting member 124.

In addition, in the preferred embodiment, the lower housing 1113 can further include a battery cover 11131 respective to the power supply module 126, such that the power supply module 126 can be covered or the replacement of the battery by the user 2 can be made easier. Further, the upper housing 1112 and the lower housing 1113 can be assembled by a supersonic heating process so as to increase the air-tightness of the air chamber 11111.

As described above, by providing the whistle capable of detecting an air pressure in accordance with the present invention, since an air-pressure sensor is introduced to detect the air of user's whistling, and since the detection signal is transmitted to the foreign electronic mobile device, so messages of user's urgent need can be clearly understood through the transmission of the internet. In addition, since the air chamber is divided into two voice channels for making simultaneously the lower tone and the high tone respectively, the rescue team rushing to help can easily locate the user, even at a circumstance of invisible night or dense fog, such that the rescue efficiency can be substantially enhanced.

Further, since a pressure-detecting member is included to the whistle of the present invention, so the user can alternatively generate the detection signal crying for help by simply depressing a button of the whistle, without an air-blowing motion from the user. Therefore, no matter what the reason is for the user unable to make the noise by blowing the whistle (a damage to the blow hole or any reason the like), the detection signal can still be formed for informing people distance away. Thus, the convenience of the whistle with an air-pressure sensor in accordance with the present invention is obvious.

While the present invention has been particularly shown and described with reference to a preferred embodiment, it will be understood by those skilled in the art that various changes in form and detail may be without departing from the spirit and scope of the present invention.

What is claimed is:

1. A whistle capable of detecting an air pressure, comprising:
a housing, further including:
a shell body, having an interior space; and
a division assembly, dividing the interior space into an air chamber and an accommodation chamber, having a detection opening communicative in space with the air chamber, further having a blow hole for a user to blow an air into the air chamber; and
a circuit board module, located inside the shell body, further including:
a main board, having at least a portion thereof located inside the accommodation chamber, having an air-detecting region located at a place corresponding to the detection opening; and
an air-pressure sensor, located in the air-detecting region for detecting the air, transmitting a first detection signal upon detecting the air.

2. The whistle capable of detecting an air pressure of claim 1, wherein the circuit board module further includes a transmission module electrically coupled with the air-pressure sensor for connecting communicatively an electronic mobile device, the transmission module transmitting the first detection signal to the electronic mobile device after receiving the first detection signal.

3. The whistle capable of detecting an air pressure of claim 2, wherein the housing further includes a depression member, and the circuit board module further includes a pressure-detecting member mounted on the main board with respect to the depression member and electrically coupled with the transmission module, the pressure-detecting member being to transmit a second detection signal to the electronic mobile device through the transmission module upon the depression member being depressed.

4. The whistle capable of detecting an air pressure of claim 3, wherein the circuit board module further includes a light-emitting module mounted on the main board and electrically coupled with the air-pressure sensor and the pressure-detecting member, the light-emitting module being to light on upon receiving at least one of the first detection signal and the second detection signal.

5. The whistle capable of detecting an air pressure of claim 4, wherein the circuit board module further includes a power supply module mounted on the main board and electrically coupled with the light-emitting module, the power supply module being to energize the light-emitting module.

6. The whistle capable of detecting an air pressure of claim 4, wherein the light-emitting module includes a plurality of light-emitting diodes (LED).

7. The whistle capable of detecting an air pressure of claim 1, wherein the air chamber further has a first acoustic window and a second acoustic window isolated from the first acoustic window.

8. The whistle capable of detecting an air pressure of claim 7, wherein the shell body further includes an upper housing and a lower housing, the upper housing having a first acoustic outlet and a second acoustic outlet separated from the first acoustic outlet by at least one separation plate, the first acoustic outlet being communicative in space with the first acoustic window, the second acoustic outlet being communicative in space with the second acoustic window, the upper housing and the lower housing being connected structurally by the division assembly.

9. The whistle capable of detecting an air pressure of claim 8, wherein the division assembly further includes a first division plate and a second division plate, the first division plate being connected to the upper housing, the second division plate being connected to the lower housing, the second division plate further including a first planar portion, a vertical portion and a second planar portion, the first planar portion having the detection opening, the vertical portion connecting the first planar portion and the second planar portion for forming an L-shaped structure.

10. The whistle capable of detecting an air pressure of claim 1, wherein the air-pressure sensor is inserted in the detection opening.
